(19) United States
(12) Patent Application Publication
(10) Pub. No.: US 2008/0122563 A1
(43) Pub. Date: May 29, 2008

(54) INSTANTANEOUS TRIP MECHANISM FOR MOULD CASED CIRCUIT BREAKER

(75) Inventor: Jung-Chun SONG, Seoul (KR)

Correspondence Address: GREENBLUM & BERNSTEIN, P.L.C., 1950 ROLAND CLARKE PLACE, RESTON, VA, 20191, US

(73) Assignee: LS INDUSTRIAL SYSTEMS CO., LTD., Seoul (KR)

(21) Appl. No.: 11/467,648

(22) Filed: Aug. 28, 2006

(51) Int. Cl. H01H 71/24; H01H 71/12

(52) U.S. Cl. 335/176; 335/18

(57) ABSTRACT

An instantaneous trip mechanism for a mould cased circuit breaker in a trip mechanism of a mould cased circuit breaker, the instantaneous trip mechanism capable of easily adjusting a trip current sensitivity for initiating an instantaneous trip operation and of fabricating a reliable mould cased circuit breaker by employing a simple construction for the adjusting unit and supporting a constant trip current sensitivity by products, the instantaneous trip mechanism for the mould cased circuit breaker comprising: a fixed electromagnet for generating a magnetic force which is changed according to a current flowing on a circuit; an armature disposed to face the fixed electromagnet and rotatable to a position for tripping the mould cased circuit breaker by the magnetic force from the fixed electromagnet when a great current exceeding a normal current flows on the circuit; a spring for elastically biasing the armature in a direction of being separated from the fixed electromagnet; an adjusting dial member having a cam surface for adjusting a gap between the armature and the fixed electromagnet; and an adjusting bar having one end contacted with the cam surface of the adjusting dial member and another end contacted with the armature, and rotatable to change the gap by pushing the armature according to a position of being contacted with the cam surface of the adjusting dial member.

### BACKGROUND OF THE INVENTION

1. Field of the Invention

The present invention relates to a mould cased circuit breaker, and particularly, to an instantaneous trip mechanism for a mould cased circuit breaker which is capable of adjusting a trip current sensitivity using a simple mechanism and of fabricating a reliable mould cased circuit breaker supplying a constant trip current sensitivity according to products.

2. Background of the Invention

In general, a mould cased circuit breaker denotes one of electrical appliances which automatically breaks a circuit when an over current or short-circuit current is electrically generated on a circuit between a power source and an electrical load.

The mould cased circuit breaker roughly includes a terminal unit connected to a power source or electrical load, a fixed contact and a movable contact which are electrically connected to the terminal unit, a switching mechanism for switching (opening or closing) a circuit by moving the movable contact to a position at which it is contacted with the fixed contact or a position at which it is separated from the fixed contact, and an instantaneous trip mechanism for detecting (sensing) a large current when the large current greater than a normal current flows over the circuit to thus trigger the switching mechanism to be moved to a trip position for opening (switching on) the circuit.

The mould cased circuit breaker having such construction is typically used such that it is connected to the circuit to switch on/off the circuit between a power source and an electrical load or to break the circuit when an abnormal current is generated to thereby protect the electrical load and the circuit.

Unlike manually driving the switching mechanism to the switching position of the circuit, on the other hand, when an abnormal current is generated on the circuit, the mould cased circuit breaker senses the abnormal current generated to thus be moved to a position where the circuit is automatically broken. Such operation is referred to as a trip operation.

When a current corresponding to many times of a rated current flows over the circuit, an instantaneous trip function is required such that the mould cased circuit breaker senses it to instantaneously break the circuit (i.e., perform the trip operation).

The present invention relates to an enhanced mechanism for the instantaneous trip of the mould cased circuit breaker. An instantaneous trip mechanism of a mould cased circuit breaker according to the related art will now be described.

FIG. 1 is a sectional view illustrating a structure of a typical mould cased circuit breaker, and FIG. 2 is a longitudinal sectional view illustrating an instantaneous trip mechanism according to the present invention.

As illustrated in FIGS. 1 and 2, a typical mould cased circuit breaker 100 includes fixed contacts 110 and 120 connected to a power source or an electrical load, a movable contact 130 rotatable to a position where the movable contact 130 is contacted with the fixed contacts 110 and 120 (ON) and separated therefrom (OFF or TRIP), a switching mechanism 140 for moving the movable contact 130 to the contacted or separated position to switch on/off a circuit, a handle 150 connected to the switching mechanism 140 to manually drive the switching mechanism 140, an instantaneous trip mechanism 160 for sensing a case that a large current exceeding a normal current flows over the circuit between the power source and the electrical load to thereby trigger the switching mechanism 140 to be moved to a trip position for switching on the circuit, and an arc extinguishing mechanism 170 for extinguishing an arc generated between the movable contact 130 and the fixed contacts 110 and 120 when the movable contact 130 is separated from the fixed contacts 110 and 120.

A detailed construction of the instantaneous trip mechanism 160 according to the embodiment of the related art will now be explained with reference to FIG. 2.

As illustrated in FIG. 2, the instantaneous trip mechanism 160 according to the related art includes a fixed electromagnet fixedly-disposed on a conductor between the fixed contacts 110, 120 and a terminal for generating a magnetic attraction force in proportion to a large current when the large current flows over the circuit; and an armature 162 installed to face the fixed electromagnet 161, rotatable to a position close to the fixed electromagnet 161 or a position away from the fixed electromagnet 161, and having an operation unit 162a for performing a trip operation at its upper end portion.

The trip mechanism 160 according to the related art includes a shooter 163 one end of which has a locker arm 153a and another end of which is connected to the switching mechanism 140, a cross bar 164 rotated to a position to lock or unlock the shooter 163, and rotatable to a position for unlocking the shooter by a pushing by the operation unit 162a of the armature 162, and an adjusting dial 166 having a side surface which is implemented as a cam surface, for adjusting a trip current sensitivity of the instantaneous trip mechanism.

The trip mechanism 160 according to the related art further includes a first driving force transfer bar 165 having an upper end contacted with the cam surface 166a of the adjusting dial 166 and a lower end for transferring a driving force, and rotatable according to a displacement of a contact point on the cam surface 166a, the displacement resulting from the rotation of the adjusting dial 166; a second driving force transfer bar 168 rotatably installed at a position at which the upper end 162a of the armature 162 is contacted to thusly transfer the driving force from the first driving force transfer bar 165 to the armature 162; and a spring 167 upper end of which is supported by the first driving force transfer bar 165 and lower end of which is supported by the second driving force transfer bar 168 to thusly transfer the driving force from the first driving force transfer bar 165 to the second driving force transfer bar 168 and simultaneously to maintain a relative position between the adjusting dial 166 and the first driving force transfer bar 165 and a relative position between the second driving force transfer bar 168 and the armature 162 as a set (adjusted) position.

An upper surface of the adjusting dial 166 has a connection groove (not shown) for a screw driver to allow a user to adjust the trip current sensitivity of the mould cased circuit breaker. The side surface of the adjusting dial 166 is implemented as the cam surface 166a having a varying radius such that the first driving force transfer bar 165 which is contacted with the cam surface 166a is rotated according to a contacted position with the cam surface 166a.

The armature 162 is biased by a torsion spring (a reference numeral is not given therefor) disposed at its lower portion thus to receive an elastic force in a direction closer to the fixed electromagnet 161 . The upper end 162a of the armature 162 is stopped by the second driving force bar 168. Accordingly, the armature 162 can continuously be in a state of being spaced apart from the fixed electromagnet 161.

An operation for adjusting a trip current sensitivity of the instantaneous trip mechanism for the mould cased circuit breaker according to the related art having such construction will now be explained.

Sensitivity with respect to a trip current depends on a distance between the fixed electromagnet 161 and the armature 162. That is, a short distance therebetween obtains a high sensitivity, while a long distance therebetween obtains a low sensitivity. Therefore, upon adjusting the distance to be short, the trip mechanism becomes as sensitive as initiating the trip operation even when a normal current, namely, a current close to a rated current flows. Upon adjusting the distance to be long, the trip mechanism performs the trip operation only when a current considerably larger than the rated current flows over the circuit.

Thus, upon rotating the adjusting dial 166 in a clockwise direction to obtain a high sensitivity with respect to the trip current, the upper end of the first driving force transfer bar 165 is contacted with a position where the radius of the cam surface 166a is great and simultaneously the first driving force transfer bar 165 is rotated in the clockwise direction. Accordingly, the spring 167 is descended to release (unlock) the second driving force transfer bar 168 pushed. The second driving force transfer bar 168 is then rotated in the clockwise direction. Consequently, an elastic bias force of the torsion spring is applied to the armature 162 which is thereby moved closely toward the fixed electromagnet 161 by a distance corresponding to a distance that the second driving force transfer bar 168 has been rotated. Hence, the current sensitivity over the circuit by which the trip operation is initiated can be adjusted to be higher,

Contrarily, in order to obtain a low sensitivity with respect to the trip current, namely, to adjust the current on the circuit for initiating the trip operation to be much greater than the rated current, when rotating the adjusting dial 166 in the counterclockwise direction, the upper end of the first driving force transfer bar 165 is contacted with a position where the radius of the cam surface 166a is small and simultaneously the first driving force transfer bar 165 is rotated in the counterclockwise direction, Accordingly, the spring 167 is ascended to push the second driving force transfer bar 168. The second driving force transfer bar 168 is thereby rotated in a counterclockwise direction. Consequently, the armature 162 overcomes the elastic bias force of the torsion spring to thusly be moved away from the fixed electromagnet 161 by a distance corresponding to a distance that the second driving force transfer bar 168 is rotated. Hence, the current sensitivity over the circuit for initiating the trip operation can be adjusted to be lower, namely, to allow the armature 162 to be operated with respect to a great current over the circuit.

The trip operation of the instantaneous trip mechanism according to the related art will now be explained.

After adjusting the current over the circuit that the trip mechanism initiates the trip operation, namely, adjusting the trip sensitivity, if an abnormal current (e.g., a short-circuit current) is generated over the circuit as a large current corresponding to many times of the rated current, the fixed electromagnet 161 is magnetized by the large current to thereby generate a great magnetic attraction force. Here, the magnetic attraction force of the fixed electromagnet 161 is much greater than a brake force of the second driving force transfer bar 168 by the spring 167. Accordingly, the operation unit 162a of the armature 162 pushes out the second driving force transfer bar 168 and is rotated in the counterclockwise direction, thereby hitting the lower end of the cross bar 164. The cross bar 164 is then rotated in the clockwise direction by the hitting of the operation unit 162a of the armature 162. Accordingly, the locker arm is unlocked and thereby the shooter 163 is rotated to thereafter trigger the switching mechanism 140 of FIG. 1 to be moved to the trip position. Therefore, the movable contact 130 connected to the switching mechanism 140 is separated from the fixed contacts 110 and 120 by the movement of the switching mechanism 140 so as to be in a tripped state in which the circuit is broken.

The trip mechanism for the mould cased circuit breaker of the related art has a complex construction, and uses the elastic force of the spring 167 to maintain a gap between the fixed electromagnet 161 and the armature 162. Accordingly, when massively producing the mould cased circuit breaker, since the elasticity of the spring 167 is not constant, the gap between the fixed electromagnet 161 and the armature 162 may be different according to products even if the adjusting dial 166 is rotated by a predetermined angle. Therefore, it is disadvantageously difficult to fabricate a reliable mould cased circuit breaker having a constant current value for initiating the trip operation.

On the other hand, an arrangement for double installing a mould cased circuit breaker (i.e., a main mould cased circuit breaker) for switching and protecting a main circuit (i.e., an upper circuit close to a power source) and a mould cased circuit breaker (i.e., a sub mould cased circuit breaker) for switching and protecting a sub circuit (i.e., a lower circuit which is divided from the upper circuit to be close to an electrical load appliance) is frequently being used even in a power distribution line in home as well as in industries. In the circuit protecting arrangement for double installing the upper and lower circuits, assuming that trip sensitivities for the mould cased circuit breakers having the instantaneous trip mechanism have been adjusted to be about the same, the mould cased circuit breakers of the upper and lower circuits are tripped at the same time or even only the mould cased circuit breaker of the upper circuit is tripped, with respect to an abnormal current much greater than the rated current.

It is not preferable in view of priorities of circuit protection that the load appliance on the lower circuit is preferentially protected with respect to the abnormal current and then the upper circuit is protected. Therefore, the mould cased circuit breaker installed on the upper circuit is required so that the instantaneous trip could be delayed as compared to the mould cased circuit breaker installed on the lower circuit.

### SUMMARY OF THE INVENTION

Therefore, an object of the present invention is to provide an instantaneous trip mechanism for a mould cased circuit breaker which is capable of adjusting a trip current sensitivity using a simple mechanism and of fabricating a reliable mould cased circuit breaker by supplying a constant sensitivity of the trip current.

Another object of the present invention is to provide an instantaneous trip mechanism for a mould cased circuit breaker, in a mould cased circuit breaker installed on an upper circuit, which capable of delaying an instantaneous trip.

To achieve these and other advantages and in accordance with the purpose of the present invention, as embodied and broadly described herein, there is provided an instantaneous trip mechanism for a mould cased circuit breaker comprising: a fixed electromagnet for generating a magnetic force which is variable depending upon a current flowing on a circuit, an armature disposed to face the fixed electromagnet and rotatable to a position at which the mould cased circuit breaker is tripped by the magnetic force from the fixed electromagnet when a large current exceeding a normal current flows over the circuit; a spring for elastically biasing the armature in a direction of being separated from the fixed electromagnet; an adjusting dial member having a cam surface for adjusting a gap between the armature and the fixed electromagnet; and an adjusting bar having one end contacted with the cam surface of the adjusting dial member and the other end contacted with the armature, and rotatable to change the gap by pushing (pressurizing) the armature according to the position contacted with the cam surface of the adjusting dial member,

According to another object of the present invention, the instantaneous trip mechanism for the mould cased circuit breaker may further comprise a delay unit connected to the armature for delaying the instantaneous trip using a stationary inertia when a large current exceeding a normal current flows over the circuit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view illustrating a structure of a typical mould cased circuit breaker;

FIG. 2 is a longitudinal sectional view illustrating an embodiment of a related art instantaneous trip mechanism;

FIG. 3 is a perspective view illustrating a construction of an instantaneous trip mechanism for a mould cased circuit breaker in accordance with the one embodiment of the present invention;

FIGS. 4A and 4B are views of an operation state of main parts, which illustrate operations for adjusting a trip current sensitivity of the instantaneous trip mechanism for the mould cased circuit breaker in accordance with the one embodiment of the present invention,

wherein FIG. 4A illustrates a state that the trip current sensitivity is adjusted to be high, namely, a state that a trip initiating current is adjusted to be small, and FIG. 4B illustrates a state that the trip current sensitivity is adjusted to be low, namely a state that the trip initiating current is adjusted to be great;

FIG. 5 is a perspective view illustrating a construction of an instantaneous trip mechanism for a mould cased circuit breaker in accordance with another embodiment of the present invention; and

FIG. 6A-6C are views illustrating an operation state of main parts of the instantaneous trip mechanism for a mould cased circuit breaker in accordance with the another embodiment of the present invention,

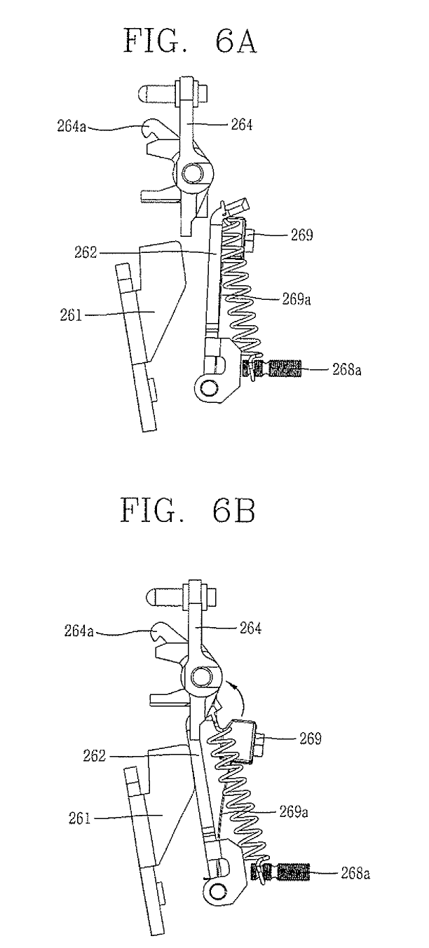

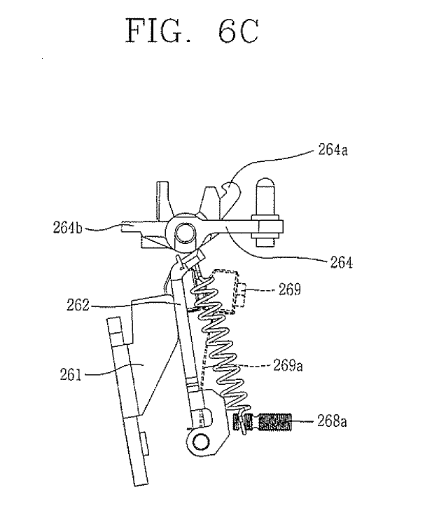

wherein FIG. 6A illustrates an operation state of main parts of the instantaneous trip mechanism for a mould cased circuit breaker in accordance with the another embodiment of the present invention when conducting a normal current, FIG. 6B illustrates an operation state that an armature of the instantaneous trip mechanism for a mould cased circuit breaker in accordance with the another embodiment of the present invention is first moved toward a fixed electromagnet by an attraction force and then a delay weight is stopped by a stationary inertia, and FIG. 6C illustrates an operation state that the delay weight of the instantaneous trip mechanism for a mould cased circuit breaker in accordance with the another embodiment of the present invention, the delay weight having been stopped by the stationary inertia, is rotated by an elastic force of a spring element to hit a cross bar, thereby rotating the cross bar.

### DETAILED DESCRIPTION OF THE INVENTION

Description will now be given in detail of the present invention, with reference to the accompanying drawings.

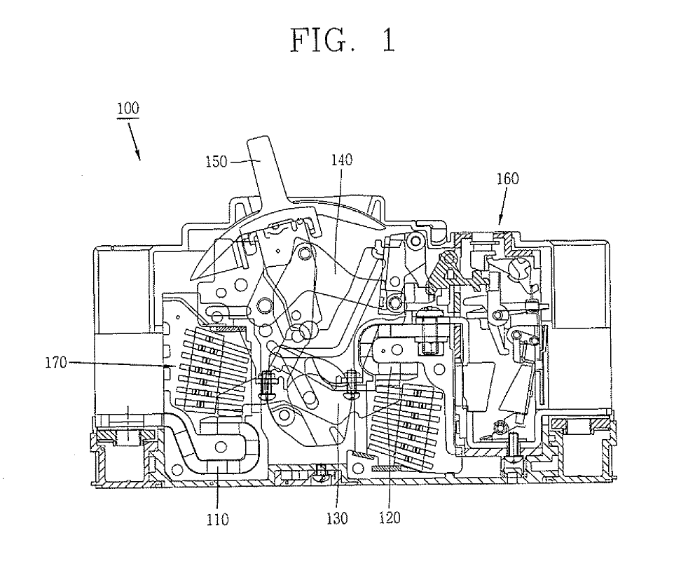

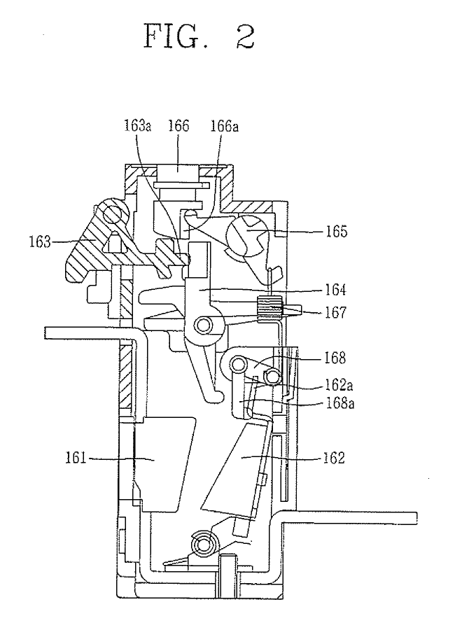

A preferred embodiments of an instantaneous trip mechanism for a mould cased circuit breaker according to the present invention will now be explained with reference to the accompanying drawings. The instantaneous trip mechanism for the mould cased circuit breaker according to the present invention may refer to a mould cased circuit breaker shown in FIG. 1. The typical construction of the mould cased circuit breaker shown in FIG. 1 is the same as that of the related art aforementioned, explanation of which will not be repeated accordingly.

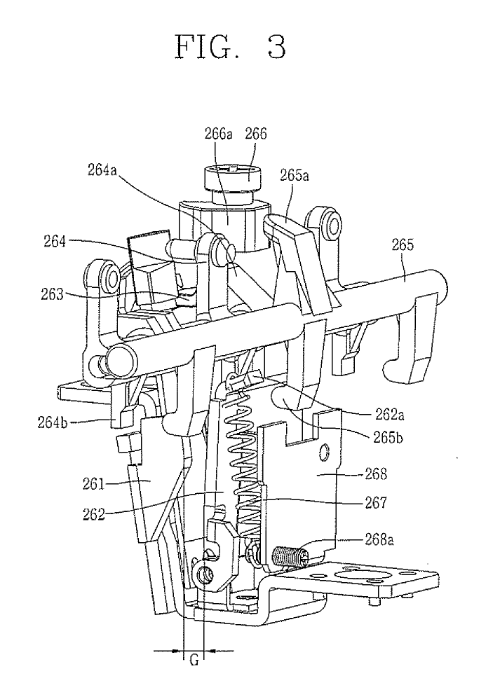

First, FIG. 3 is a perspective view illustrating a construction of an instantaneous trip mechanism for a mould cased circuit breaker in accordance with one embodiment of the present invention.

As illustrated in FIG. 3, a trip mechanism for a mould cased circuit breaker according to one embodiment of the present invention includes a fixed electromagnet 261 for generating a magnetic force which is variable upon a current flowing on a circuit, an armature 262 disposed to face the fixed electromagnet 261, and rotatable to a position at which the mould cased circuit breaker is tripped by the magnetic force from the fixed electromagnet 261 when a large current exceeding a normal current flows over the circuit, a spring 267 for elastically biasing the armature 262 toward a direction of being separated from the fixed electromagnet 261, an adjusting dial member 266 having a cam surface 266a for adjusting a gap G between the armature 262 and the fixed electromagnet 261, and an adjusting bar 265 having one end 265a contacted with the cam surface 266a of the adjusting dial member 266 and the other end 265b contacted with the armature 262, and rotatable to change the gap G by pressing (pushing) the armature 262 according to the position contacted with the cap surface 266a of the adjusting dial member 266. The another end 265b of the adjusting bar 265 is formed in a bent shape to engage the armature 262.

In FIG. 3, a reference numeral 263 denotes a shooter for triggering a switching mechanism of the mould cased circuit breaker to a trip position, a reference numeral 264 denotes a cross bar for latching or releasing the shooter 263, a reference numeral 264a denotes a latch portion of the cross bar 264. Also, in FIG. 3, a reference numeral 264b denotes a driving force transfer unit of the cross bar 264 for receiving a rotation force of the armature 262, and a reference numeral 262a denotes a bent portion disposed at an upper end of the armature 262 to support an upper end of the spring 267 and to engage the adjusting bar 265 into the another end 265b. A height of the bent portion 262a is determined to correspond to the another end 265b of the adjusting bar 265. A bent angle is determined such that the armature 262 is prevented from being rotated in the clockwise direction, but is moved toward the fixed electromagnet 261 by an attraction force during a trip operation so as to be rotatable in the counterclockwise direction.

The instantaneous trip mechanism for the mould cased circuit breaker according to the present invention illustrated in FIG. 3 may further include a unit connected to the spring 267 for changing an angle between the spring 267 and the armature 262 to thusly adjust an elastic bias force of the spring 267. The unit for changing the angle between the spring 267 and the armature 262 includes an adjusting screw 268a connected to one end of the spring 267, and a support member 268 for supporting the adjusting screw 268a. Here, the support member 268 is formed as a plate member having a threaded portion which is disposed in a through hole through which the adjusting screw 268a passes.

The armature 262 receives a moment which is changed in proportion to a tangent value of an angle between the spring 267 and the armature 262 based upon an elastic force of the spring 267. That is, the armature 262 receives the moment of a direction of being separated from the fixed electromagnet 261 (e.g., a clockwise direction in FIG. 3), the direction in which the moment becomes greater as the angle between the spring 267 and the armature 262 is wider.

For example, upon rotating the adjusting screw 268a in a clockwise direction by using a screw driver, the adjusting screw 268a is moved forward through the through hole in which the threaded portion is disposed. Accordingly, the angle between the spring 267 and the armature 262 becomes wider. The armature 262 thusly receives a great moment of a direction of being separated from the fixed electromagnet 261, namely, of the clockwise direction in FIG. 3. Furthermore, upon rotating the adjusting screw 268a in a counterclockwise direction by using the screw driver, the adjusting screw 268a is moved backward through the through hole in which the threaded portion is disposed. Accordingly, the angle between the spring 267 and the armature 262 becomes narrower. The 1o armature 262 thusly receives a small moment of a direction of being separated from the fixed electromagnet 261, namely, of the counterclockwise direction in FIG. 3. Thus, the armature 262 receives the moment of the direction of being separated from the fixed electromagnet 261, namely, the clockwise direction in FIG. 3. However, the bent portion disposed at the upper end of the armature 262 is engaged in the another end 265b of the adjusting bar 265, which prevents the armature from being rotated in the clockwise direction.

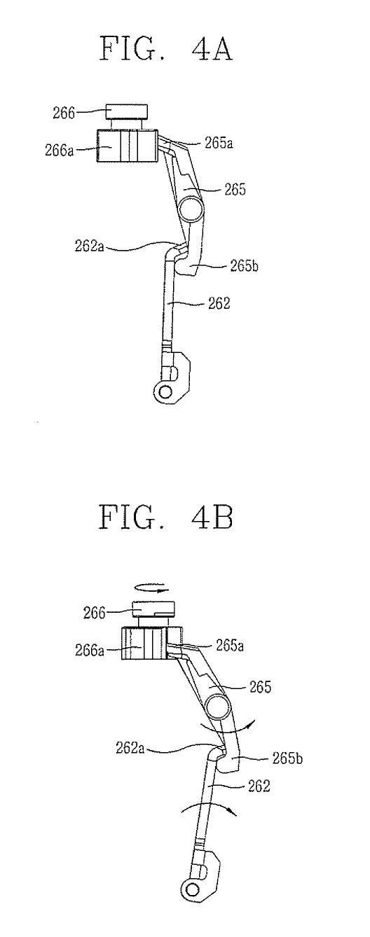

Now, an operation of adjusting a trip sensitivity of the instantaneous trip mechanism for the mould cased circuit breaker in accordance with the one embodiment of the present invention having such construction will now be explained with reference to FIGS. 4A and 4B.

FIGS. 4A and 4B are views of an operation state of main parts, which illustrate operations for adjusting a trip current sensitivity of the instantaneous trip mechanism for the mould cased circuit breaker in accordance with the one embodiment of the present invention.

FIG. 4A illustrates a state that the trip current sensitivity is adjusted to be high, namely, a state that a trip initiating current is adjusted to be small.

FIG. 4B illustrates a state that the trip current sensitivity is adjusted to be low, namely, a state that the trip initiating current is adjusted to be great.

First, a screw driver is inserted into a screw driver inserting groove (not having a reference number designated) formed on a top surface of the adjusting dial 266, and then rotated in a clockwise direction. The one end 265a of the adjusting bar 265, as illustrated in FIG. 4A, is accordingly contacted with a portion having a great radius in the cam surface 266a of the adjusting dial 266, and thereby the adjusting bar 265 is rotated. Therefore, the armature 262 overcomes the elastic force of the spring 267 illustrated in FIG. 3, and is rotated in a counterclockwise direction. A gap G between the armature 262 and the fixed electromagnet 261 accordingly becomes narrower. Hence, as the trip mechanism has a high trip sensitivity, the trip mechanism performs the trip operation when a current which is relatively a bit greater than a rated current (e.g., a current corresponding to a several ten percents greater than the rated current) flows on a circuit.

Contrarily, the screw driver is inserted into the screw driver inserting groove to be rotated in a counterclockwise direction. Then, the one end 265a of the adjusting bar 265, as illustrated in FIG. 4B, is contacted with a portion having a small radius in the camp surface 266a of the adjusting dial 266. Accordingly, the adjusting bar 265 is rotated in a counterclockwise direction by the elastic force of the spring 267 illustrated in FIG. 3. Therefore, as the armature 262 is rotated in a clockwise direction by the elastic force of the spring 267 illustrated in FIG. 3, the gap G between the armature 262 and the fixed electromagnet 261 becomes wider. Hence, as the trip mechanism has a low sensitivity becomes, the trip mechanism performs the trip operation when a current considerably greater than the rated current (e.g., a great current corresponding to several times of the rated current) flows over the circuit.

A trip operation of the instantaneous trip mechanism for the mould cased circuit breaker in accordance with the one embodiment of the present invention will now be explained with reference to FIG. 3 hereafter.

After adjusting the current over the circuit for initiating the trop operation of the trip mechanism, namely, after adjusting the trip sensitivity, for example, when an abnormal current (e.g., short-circuit current) is generated on the circuit as a great current corresponding to several times of the rated current, the fixed electromagnet 261 is magnetized by the great current to thereby generate a great magnetic attraction force. Here, the magnetic attraction force of the fixed electromagnet 261 is much greater than the elastic force of the spring 267. Accordingly, the armature 262 is rotated in a counterclockwise direction in the drawing. The driving force transfer unit 264b of the cross bar 264 is then rotated in a clockwise direction by the pushing of the armature 262. The latch portion of the cross bar 264 is then released from the shooter 263. Thereafter, the shooter 263 triggers the switching mechanism 140 of FIG. 1 thus to be moved to a trip position. Hence, the movable contact 130 connected to the switching mechanism 140 is separated from the fixed contacts 110 and 120 by driving the switching mechanism, and thereby the circuit is broken, namely, is in a tripped state.

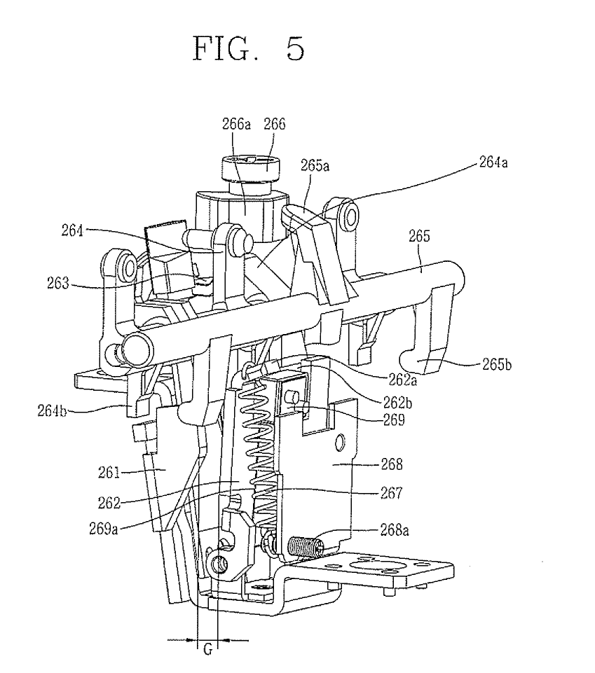

FIG. 5 is a perspective view illustrating a construction of an instantaneous trip mechanism for a mould cased circuit breaker in accordance with another embodiment of the present invention. An instantaneous trip mechanism for a mould cased circuit breaker in accordance with the another embodiment of the present invention illustrated in FIG. 5 may be applied to an upper mould cased circuit breaker in case that a main mould cased circuit breaker close to a power source and a sub mould cased circuit breaker close to an electrical load are double installed on a power supply circuit. In other words, the another embodiment of the present invention may be characterized by having a trip delay unit for tripping the main mould cased circuit breaker with delay as compared to the sub mould cased circuit breaker. Other constructions and operations in the another embodiment of the present invention are the same as or similar to those in the one embodiment of the present invention aforementioned, detailed explanation for which will not be repeated accordingly.

As illustrated in FIG. 5, an instantaneous trip mechanism for a mould cased circuit breaker in accordance with another embodiment of the present invention comprises a fixed electromagnet 261 for generating a magnetic force which is changed according to a current flowing over a circuit, an armature 262 disposed to face the fixed electromagnet 261, and rotatable to a position at which the mould cased circuit breaker is tripped by the magnetic force from the fixed electromagnet 261 when a large current exceeding a normal current flows over the circuit, a spring 267 for elastically biasing the armature 262 toward a direction of being separated from the fixed electromagnet 261, an adjusting dial member 266 having a cam surface 266a for adjusting a gap G between the armature 262 and the fixed electromagnet 261, and an adjusting bar 265 having one end 265a contacted with the cam surface 266a of the adjusting dial member 266 and another end 265b contacted with the armature 262, and rotatable to change the gap G by pressing (pushing) the armature 262 according to the position contacted with the cap surface 266a of the adjusting dial member 266. The another end 265b of the adjusting bar 265 is formed in a curved (bent) shape to engage the armature 262.

In FIG. 5, a reference numeral 263 denotes a shooter for triggering a switching mechanism of the mould cased circuit breaker to a trip position, a reference numeral 264 denotes a cross bar for latching or unlatching the shooter 263, a reference numeral 264a denotes a latch portion of the cross bar 264. Also, in FIG. 3, a reference numeral 264b denotes a driving force transfer unit of the cross bar 264 for receiving a rotation force of the armature 262, and a reference numeral 262a denotes a bent portion disposed at an upper end of the armature 262 to support an upper end of the spring 267 and to engage the adjusting bar 265 into the another end portion 265b.

The instantaneous trip mechanism for the mould cased circuit breaker according to the present invention illustrated in FIG. 5 may further include a unit connected to the spring 267 for changing an angle between the spring 267 and the armature 262 to thusly adjust an elastic bias force of the spring 267. The unit for changing the angle between the spring 267 and the armature 262 includes an adjusting screw 268a connected to one end of the spring 267, and a support member 268 for supporting the adjusting screw 268a. Here, the support member 268 is formed as a plate member having a threaded portion which is disposed in a through hole through which the adjusting screw 268a passes.

The instantaneous trip mechanism for the mould cased circuit breaker according to the present invention may further include delay units 269 and 269a connected to the armature 262 and using a stationary inertia to delay an instantaneous trip when a great current exceeding a normal current flows on a circuit.

The delay units 269 and 269a include a spring element 269a one end of which is fixed to the armature 262 for charging an elastic energy when the armature 262 is rotated and then discharging the charged elastic energy after a certain time delay, and a weight 269 fixed to the other end of the spring element 269a for providing a stationary inertia force to the spring element when the armature is rotated thus to allow the spring element to charge the elastic energy and to discharge the elastic energy after a predetermined delay, the weight 269 rotatable together with the spring element 269a by the elastic energy of the spring element 269a.

Here, a passing recess 262b is provided at a position corresponding to an upper portion of the armature 262 to thus allow a rotational movement of the weight 269. Preferably, the spring element 269a is constructed as a plate spring, and more particularly of a thin stainless-steel plate.

The spring element 269a may be formed of a typical coil spring rather than the plate spring.

The weight 269 may constructed of a roughly hexahedral weight support member (for which a reference number is not designated), which may be formed of a synthetic resin, having a hole for inserting therein the other end of the spring element 268a and fixed and supported by a fixing unit such as and a rivet for fixedly supporting the inserted the other end of the spring element 269a, and a metallic weight member (not shown) fixedly supported by being inserted in the weight support member. A weight of the metallic weight member may be determined according to a delay time which is required such that a tripping time point of the mould cased circuit breaker installed on the main circuit could preferably be later than that of the mould cased circuit breaker installed on the sub circuit.

The weight 269 is disposed at a position facing a central driving force transfer unit of three driving force transfer units 264b of the cross bar 264 of FIG. 5. The weight 269 has a surface facing a central one of the three driving force transfer units 264b of the cross bar 264, the corresponding portion of the mould cased circuit breaker for tripping the mould cased circuit breaker, namely, as a portion for hitting the central one of the three driving force transfer bars 264b of the cross bar 264. With reference to FIGS. 6A-6C, on the other hand, an operation of tripping with delay the instantaneous trip mechanism for the mould cased circuit breaker in accordance with the another embodiment of the present invention will now be explained.

FIG. 6A-6C are views illustrating an operation state of main parts of the instantaneous trip mechanism for a mould cased circuit breaker in accordance with the another embodiment of the present invention, wherein FIG. 6A illustrates an operation state of main parts of the instantaneous trip mechanism for a mould cased circuit breaker in accordance with another embodiment of the present invention when conducting a normal current.

As illustrated in FIG. 6A, as aforementioned with relation to the instantaneous trip mechanism for the mould cased circuit breaker according to the one embodiment of the present invention when a normal current flows on the circuit on which the mould cased circuit breaker is installed, the bent portion 262a (refer to FIG. 5) of the armature 262 is engaged to the other end 265b of the adjusting bar 265 at a position spaced apart from the fixed electromagnet 261 by the spring 267 by a preset gap G, and accordingly the armature maintains its position. In this state, the spring element 269a maintains its state of being approached to the armature 262 in a state almost without charging the elastic energy.

FIG. 6B illustrates an operation state that an armature of the instantaneous trip mechanism for a mould cased circuit breaker in accordance with another embodiment of the present invention is first moved toward a fixed electromagnet by an attraction force and then a delay weight is stopped by a stationary inertia.

As illustrated in FIG. 6B, when a great current exceeding a normal current flows over the main circuit close to the power source at which the mould cased circuit breaker is installed, the armature 262 is rotated toward the fixed electromagnet 261 by the magnetic attraction force of the fixed electromagnet 261 which has been magnetized by the great current. Thereafter, one end of the spring element 269a fixed to the armature 262 which is rotated in a counterclockwise direction in FIG. 6B is rotated in the counterclockwise direction together with the armature 262. However, the another end of the spring element 269a temporarily maintains its stationary state by the stationary inertia force generated by the weight fixed to the another end, Accordingly, the middle portion of the spring element 269a is bent to charge the elastic energy.

FIG. 6C illustrates an operation state that the delay weight of the instantaneous trip mechanism for a mould cased circuit breaker in accordance with another embodiment of the present invention, the delay weight having been stopped by the stationary inertia, is rotated by an elastic force of a spring element to hit a cross bar, thereby rotating the cross bar.

As illustrated in FIG. 6C, after a certain time delay, the spring element 269a, which has charged the elastic energy by being bent at its middle portion by the stationary inertia force generated by the weight 269, discharges the elastic energy having charged. Accordingly, the weight 269 is also rotated in the counterclockwise direction along the another end of the spring element 269a which is rotated by the elastic energy discharged from the spring element 269a.

The armature 262 is provided with a passing recess 262b to thus allow the rotational movement of the weight 269. The weight 269 passed through the passing recess 262b hits the driving force transfer unit 264b of the cross bar 264 to rotate the cross bar 264 in a clockwise direction in the drawing. Consequently, the mould cased circuit breaker, which has the instantaneous trip mechanism according to the another embodiment of the present invention and is installed on the main circuit close to the power source, performs the instantaneous trip operation later than the mould cased circuit breaker installed on the sub circuit close to the load. Here, the mould cased circuit breaker installed on the sub circuit denotes the mould cased circuit breaker having the typical instantaneous trip mechanism or the instantaneous trip mechanism according to the one embodiment of the present invention other than the instantaneous trip mechanism according to the another embodiment of the present invention.

As described above, the present invention can provide the instantaneous trip mechanism for the mould cased circuit breaker so as to effectively fabricate the instantaneous trip mechanism for the mould cased circuit breaker which is capable of simply adjusting the trip current sensitivity using the simple mechanism and fabricating a reliable mould cased circuit breaker by providing a constant trip current sensitivity for each of products.

In addition, upon double installing the mould cased circuit breakers at the main circuit close to the power source and the sub circuit close to the load, it is effective to obtain the instantaneous trip mechanism for the mould cased circuit breaker in the mould cased circuit breaker installed on the upper circuit (i.e., the main circuit) so as to perform the instantaneous trip with more delay as compared to the mould cased circuit breaker installed on the lower circuit (i.e., the sub circuit).

As the present invention may be embodied in several forms without departing from the spirit or essential characteristics thereof it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

1. An instantaneous trip mechanism for a mould cased circuit breaker comprising:
a fixed electromagnet for generating a magnetic force which is variable depending upon a current flowing on a circuit;
an armature disposed to face the fixed electromagnet, and rotatable to a position for tripping the mould cased circuit breaker by the magnetic force from the fixed electromagnet when a great current exceeding a normal current flows on the circuit;
a spring for elastically biasing the armature in a direction of being separated from the fixed electromagnet;
an adjusting dial member having a cam surface for adjusting a gap between the armature and the fixed electromagnet; and
an adjusting bar having one end contacted with the cam surface of the adjusting dial member and the other end contacted with the armature, and rotatable to change the gap by pushing the armature according to a position of being contacted with the cam surface of the adjusting dial member.

2. The mechanism of claim 1, further comprising a unit connected to the spring for changing an angle between the spring and the armature so as to adjust an elastic bias force of the spring.

3. The mechanism of claim 2, wherein the unit for changing the angle between the spring and the armature includes:
an adjusting screw connected to the one end of the spring; and
a support member for supporting the adjusting screw.

4. The mechanism of claim 1, further comprising delay units connected to the armature and using a stationary inertia so as to delay an instantaneous trip when the great current exceeding the normal current flows on the circuit.

5. The mechanism of claim 4, wherein the delay units include a weight connected to the armature.

6. The mechanism of claim 4, wherein the delay units include:
a spring element one end of which is fixed to the armature and which charges an elastic energy when the armature is rotated and discharges the charged elastic energy after a certain time delay; and
a weight fixed to another end of the spring element, and supporting a stationary inertia force to the spring element when the armature is rotated thus to allow the spring element to charge the elastic energy and to discharge the elastic energy after a certain delay, the weight rotatable together with the spring element by the elastic energy of the spring element.

7. The mechanism of claim 5, wherein the weight is provided with a portion for hitting a relative portion of the mould cased circuit breaker to thusly trip the mould cased circuit breaker.

8. The mechanism of claim 6, wherein the weight is provided with a portion for hitting a relative portion of the mould cased circuit breaker to thusly trip the mould cased circuit breaker.
